(19) United States
(12) Patent Application Publication
(10) Pub. No.: US 2004/0065182 A1
(43) Pub. Date: Apr. 8, 2004

(54) Cutter module for use in a Venetian blind cutting machine

(75) Inventor: Jung-Kuei Lin, Hsinchu (TW)

Correspondence Address: BACON & THOMAS, PLLC, 625 SLATERS LANE, FOURTH FLOOR, ALEXANDRIA, VA, 22314

(73) Assignees: INDUSTRIAL TECHNOLOGY RESEARCH INSTITUTE, Hsinchu (TW); NIEN MADE ENTERPRISE CO., LTD., Taichung (TW)

(21) Appl. No.: 10/331,642

(22) Filed: Dec. 31, 2002

(30) Foreign Application Priority Data
Oct. 2, 2002 (TW) 91215606

(51) Int. Cl. B26D 1/04

(52) U.S. Cl. 83/613

(57) ABSTRACT

A cutter module for use in a Venetian blind cutting machine is disclosed to include a base, two sliding blocks and at least one cutter. The base has two parallel sliding grooves and two parallel sliding faces. The sliding blocks are slidably coupled to the sliding grooves of the base. The cutter is fastened to the sliding blocks and has two sliding faces respectively supported on the sliding faces of the base to keep the cutter in position.

### BACKGROUND OF THE INVENTION

1. Field of the Invention

The present invention relates to a Venetian blind cutting machine adapted to cut the headrail, bottom rail, and slats of a Venetian blind to the desired length and, more specifically, to a cutter module for use in the Venetian blind cutting machine.

2. Description of the Related Art

FIG. 1 illustrates a cutter module mounting structure for use in a Venetian blind cutting machine according to the prior art. According to this design, the cutter module I comprises a base 10, two sliding blocks 20, and a cutter 30. The base 10 is a flat member having two opposite sides, namely, the first side and the second side opposite to the first side. The base 10 has a set of positioning slots 11 extended through the first and second sides for receiving corresponding parts of a Venetian blind to be cut, two longitudinal sliding grooves 12 longitudinally arranged in parallel in the first side, and two longitudinal sliding faces 13 respectively extended along the longitudinal sliding grooves 12 in the first side. The sliding blocks 20 each have a coupling portion 21 coupled to one sliding groove 12 of the base 10, a sliding face 22 extended along one side of the coupling portion 21 and disposed in contact with one sliding face 13 of the base 10, and a plurality of screw holes 23. The cutter 30 has a plurality of through holes 31 symmetrically arranged at two distal ends thereof and respectively fastened to the screw holes 23 of the sliding block 20 by screws 32 for enabling the cutter 30 to be moved with the sliding blocks 20 along the sliding grooves 12 of the base 10.

After installation of the cutter module 30 in a Venetian blind cutting machine having a blind carriage, the Venetian blind to be cut is put on the blind carriage and then pushed along the top face of the blind carriage toward the cutter module 1 to force the respective parts of the Venetian blind through the respective positioning slots 11 of the base 1 in direction from the second side toward the first side. When the Venetian blind set in position, the drive unit of the Venetian blind cutting machine is driven to move along the longitudinal sliding grooves 12 (the longitudinal sliding faces 13) to cut off the parts of the Venetian blind suspended in the first side.

The aforesaid Venetian blind cutting operation is usually performed in the blind sales center. The worker of the blind sales center cuts the Venetian blind to a predetermined length subject to the consumer's requirement. After a certain number of cutting operations, the cutter 30 starts to wear. At this time, the cutter 30 must be detached from the cutter module 1 for a replacement.

In order to cut the parts of a Venetian blind accurately and to keep the cut edge of each part of the Venetian blind smooth and in shape, the cutter 30 must be positively and precisely fastened to the base 10. However, the aforesaid cutter module 1 does not achieve this requirement. Due to processing tolerance, the through holes 31 are not completely equal in diameter. After installation of the screws 32 in the through holes 31 of the cutter 30 and the screw holes 23 of the sliding blocks 20, gaps exist in the through holes 31 around the periphery of the screws 32 (see FIG. 2), resulting in imprecise positioning of the cutter 30 on the base 10. When moving the cutter 30 with the sliding blocks 20 along the longitudinal sliding grooves 12 (the longitudinal sliding faces 13) of the base 10 to cut the parts of a Venetian blind, the cutter 30 tends to be biased, resulting a deformation or uneven surface of the cut edge of each cut part of the Venetian blind.

Further, the maintenance work of a Venetian blind cutting machine in a blind sales center is normally handled by the salesmen or regular workers of the blind sales center but not by a specially trained engineer. It is difficult to the salesmen or regular workers of a blind sales center to replace the cutter of a Venetian blind cutting machine of the aforesaid conventional design.

### SUMMARY OF THE INVENTION

The present invention has been accomplished under the circumstances in view. It is therefore the main object of the present invention to provide a cutter module for a Venetian blind cutting machine, which enables the cutter to be easily and precisely fastened to the base of the cutter module.

To achieve this object of the present invention, the cutter module for a Venetian blind cutting machine comprises a base, two sliding blocks and at least one cutter. The base has a first lateral side, a second lateral side opposite to the first lateral side, a plurality of positioning slots extended through the first lateral side and the second lateral side for receiving respective parts of a Venetian blind to be cut, two parallel sliding grooves, and two sliding faces respectively extended along the sliding grooves. The sliding blocks are respectively coupled to the sliding grooves of the base for free movement along the sliding grooves of the base. The cutter is fixedly fastened to the sliding blocks and has a cutting edge suspended in the first lateral side of the base and two sliding faces respectively supported on the sliding faces of the base to guide movement of the cutter with the sliding blocks along the sliding faces of the base.

### BRIEF DESCRIPTION OF THE DRAWINGS

FIG. 1 is an exploded view of a cutter module for a Venetian blind cutting machine according to the prior art.

FIG. 2 is a schematic drawing showing gasp in the through holes of the cutter around the respective screws according to the prior art.

FIG. 3 is a plain view of a cutter module according to the present invention.

FIG. 4 is an exploded view of the cutter module according to the present invention.

FIG. 5 is a sectional view in an enlarged scale taken along line 5-5 of FIG. 3.

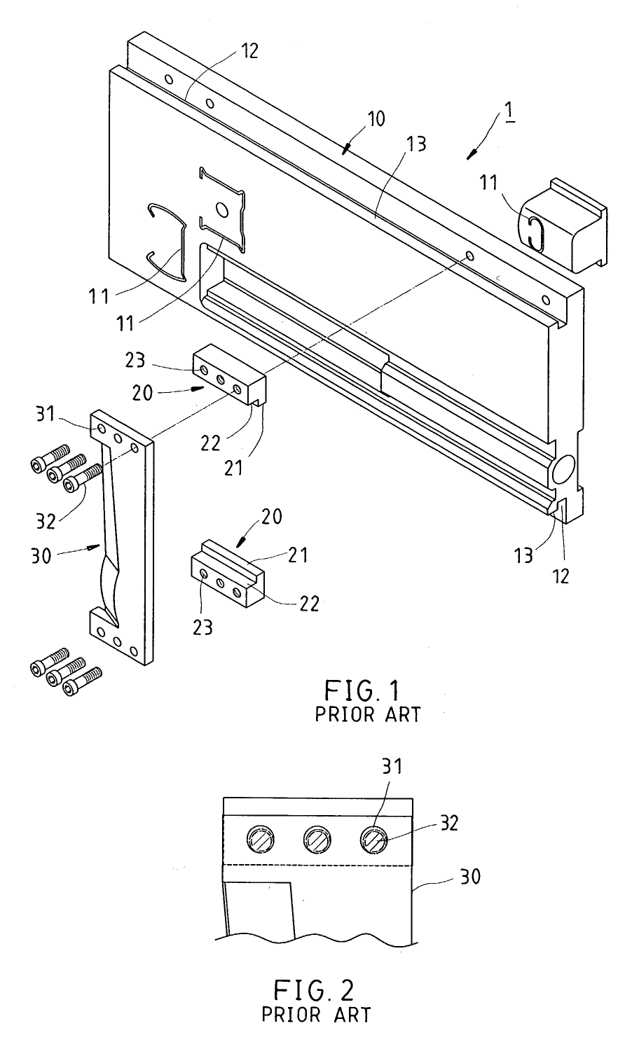

### DETAILED DESCRIPTION OF THE IVENTION

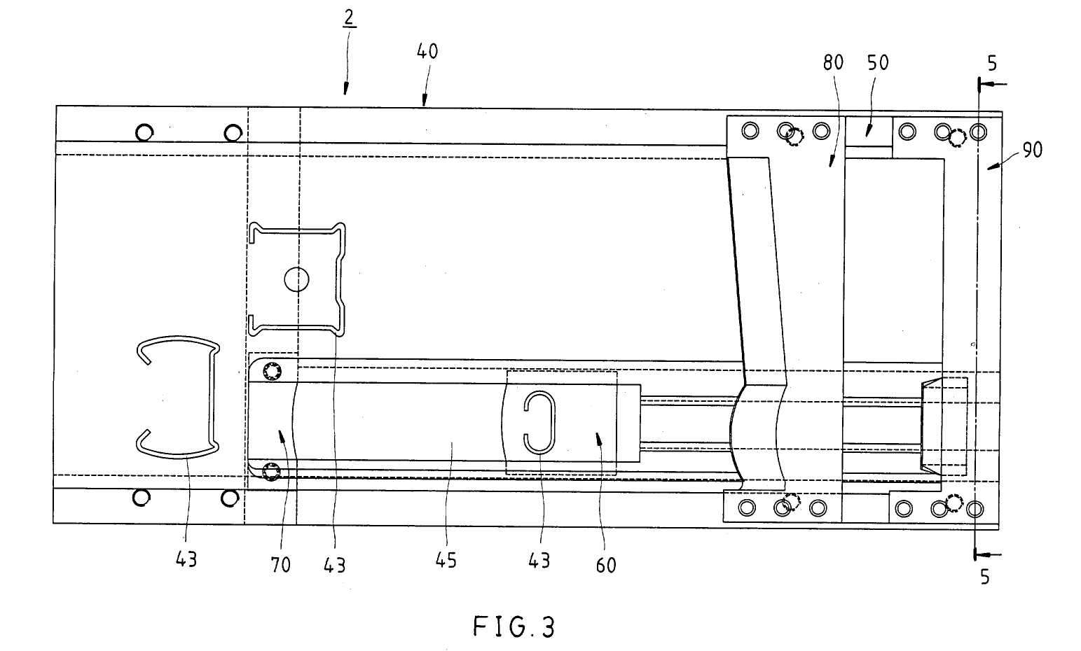

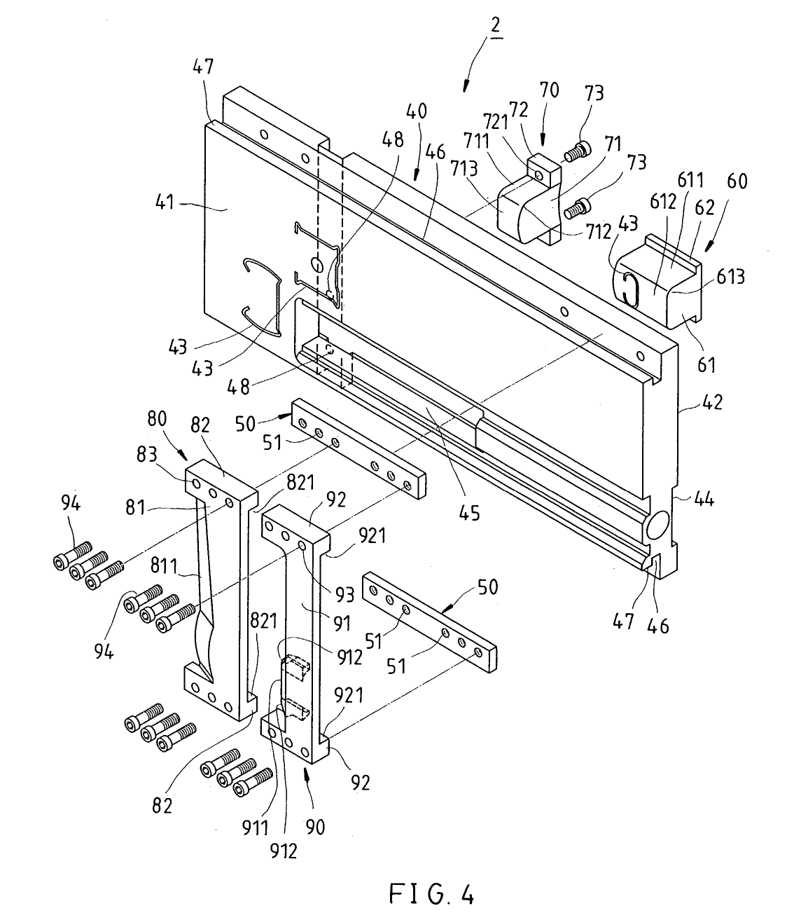

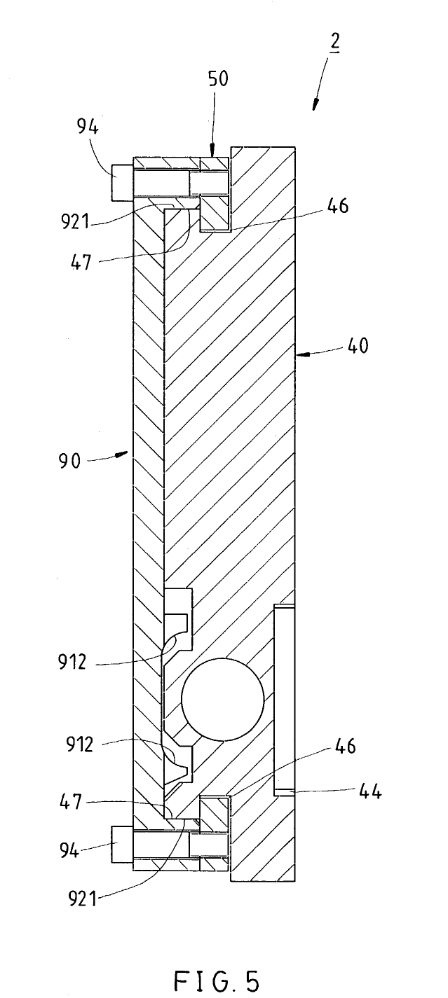

Referring to FIGS. 3-5, a cutter module 2 is shown comprised of a base 40, two sliding blocks 50, a first die block 60, a second die block 70, and two cutters, namely, the first cutter 80 and the second cutter 90.

The base 40 has a first lateral side 41, a second lateral side 42 opposite to the first lateral side, a set of positioning slots 43 extended through the first lateral side 41 and the second lateral side 42, a first longitudinal sliding groove 44 longitudinally extended in the second lateral side 42, a die block receiving opening 45 cut through the first lateral side 41 and the first longitudinal sliding groove 44 in the second lateral side 42, two second longitudinal sliding grooves 46 arranged in parallel in the top and bottom sides, and two longitudinal sliding faces 47 formed in the first lateral side 41 and respectively extended along the second longitudinal sliding grooves 46. The positioning slots 43 have a respective profile corresponding to the corresponding parts, for example, headrail, bottom rail, and slats of a Venetian blind.

The two sliding blocks 50 are respectively slidably coupled to the two second longitudinal sliding grooves 46 of the base 40, each having a plurality of screw holes 51.

The first die block 60 comprises a block body 61, two stop flanges 62 respectively outwardly extended from the block body 61 at the bottom side along the two opposite lateral sidewalls 611 of the block body 61, and two chamfered edges 613 respectively connected between the two opposite lateral sidewalls 611 and the top sidewall 612 of the block body 61. The first die block 60 is coupled to the base 40 in such a manner that the block body 61 is received in the die block receiving opening 45, keeping the top sidewall 612 in flush with the first lateral side 41 of the base 40 and the stop flanges 62 supported in the first longitudinal sliding groove 44 in the second lateral side 42 of the base 40. When installed, the first die block 60 can be moved in the die block receiving opening 45 along the first longitudinal sliding groove 44.

The second die block 70 comprises a block body 71, two mounting flanges 72 respectively outwardly extended from the block body 71 at the bottom side along the two opposite lateral sidewalls 711 of the block body 71, and two chamfered edges 712 respectively connected between the two opposite lateral sidewalls 711 and the top sidewall 713 of the block body 71. The mounting flanges 72 each have a through hole 721. Two screws 73 are respectively mounted in the through holes 721 of the mounting flanges 72 and threaded into a respective screw hole 48 in the second lateral side 42 of the base 40 to fix the second die block 70 to the second lateral side 42 of the base 40, keeping the block body 71 received in the die block receiving opening 45 and the top sidewall 713 in flush with the first lateral side 41 of the base 40.

The first cutter 80 comprises a cutter body 81 and two mounting portions 82 at two ends of the cutter body 81. The cutter body 81 has a front side, a back side, two opposite long sides, and two opposite short sides. One long side of the cutter body 81 forms a cutting edge 811. The mounting portions 82 are respectively perpendicularly extended from the back side of the cutter body 81 along the two opposite short sides. Each mounting portion 82 has a sliding face 821 perpendicular to the back side of the cutter body 81. The distance between the sliding faces 821 of the mounting portions 82 is approximately equal to the distance between the longitudinal sliding faces 47 of the base 40. The second cutter 90 comprises a cutter body 91 and two mounting portions 92 at two ends of the cutter body 91. The cutter body 91 has a front side, a back side, two opposite long sides, and two opposite short sides. The mounting portions 92 are respectively perpendicularly extended from the back side of the cutter body 91 along the two opposite short sides. Each mounting portion 92 has a sliding face 921 perpendicular to the back side of the cutter body 91. The distance between the sliding faces 921 of the mounting portions 92 is approximately equal to the distance between the longitudinal sliding faces 47 of the base 40. The second cutter 90 further has a cutting edge 911. The cutting edge 911 has two arched portions 912 spaced from each other at a distance. The curvature of the arched portions 912 is equal to the chamfered edges 613 and 712 of the die blocks 60 and 70. The first cutter 80 and the second cutter 90 each have a plurality of through holes 83 or 93. Screws 94 are respectively mounted in the through holes 83 and 93 of the cutters 80 and 90 and threaded into the screw holes 51 of the sliding blocks 50 to fix the cutters 80 and 90 to the sliding blocks 50, keeping sliding faces 821 and 921 of the mounting portions 82 and 92 of the cutters 80 and 90 respectively supported on the sliding faces 47 of the base 40. When installed, the cutters 80 and 90 can be moved with the sliding blocks 50 smoothly along the sliding faces 47 of the base 40 across the imaginary axes passing through the positioning slots 43 of the base 40, enabling the arched portions 912 of the cutting edge 911 of the second cutter 90 to be moved over the chamfered edges 613 and 712 of the die blocks 60 and 70.

When in use, the cutter module 2 is installed in a Venetian blind cutting machine, and then the first die block 60 and the first cutter 80 or the second cutter 90 are respectively connected to the die block drive and the cutter drive of the Venetian blind cutting machine. After the parts of the Venetian blind to be cut have been respectively inserted through the positioning slots 43 to the desired distance, the Venetian blind cutting machine is started to feed the first cutter 80 and the second cutter 90 to cut the parts of the Venetian blind out of the positioning slots 43.

The die block receiving slot 45 is also adapted to receive the slats of the Venetian blind to be cut. By means of the relative action between the arched portions 912 of the cutting edge 911 of the second cutter 90 and the chamfered edges 712 of the second die block 70, the second cutter 90 cuts the slats of the loaded Venetian blind in such a manner that chamfered edges are formed in the cut end of each slat. Because the use of the cutter module 2 and its connection to a Venetian blind cutting machine are same as the conventional designs, nor further detailed description is necessary.

Because the sliding faces 821 and 921 of the first and second cutters 80 and 90 are made subject to the sliding faces 47 of the base 40, the sliding faces 821 and 921 of the first and second cutters 80 and 90 and the sliding faces 47 of the base 40 match well, keeping the first and second cutters 80 and 90 precisely positioned on the base 40. Any gaps in the through holes 83 and 93 of the first and second cutters 80 and 90 around the screws 94 do not affect precise positioning of the first and second cutters 80 and 90 on the base 40. In short, fitting the sliding faces 821 and 921 of the first and second cutters 80 and 90 over the sliding faces 47 of the base 40 achieves precise positioning of the first and second cutters 80 and 90 on the base 40. Therefore, a worker can easily install the first and second cutters 80 and 90 in the base 40 without error.

Further, the second die block 70 supports the first and second cutters 80 and 90 to achieve a shearing action to cut the slats of the loaded Venetian blind. Because the second die block 70 is detachable, the user can replace the second die block 70 when the second die block 70 damaged.

What is claimed is:

1. A cutter module for use in a Venetian blind cutting machine, said cutter module comprising:
a base having a first lateral side, a second lateral side opposite to said first lateral side, a plurality of positioning slots extended through said first lateral side and said second lateral side for receiving respective parts of a Venetian blind to be cut, two parallel sliding grooves, and two sliding faces respectively extended along said sliding grooves;
two sliding blocks respectively coupled to the sliding grooves of said base for free movement along the sliding grooves of said base, and
at least one cutter fixedly fastened to said sliding blocks, said cutter having a cutting edge suspended in the first lateral side of said base and two sliding faces respectively supported on the sliding faces of said base to guide movement of said cutter with said sliding blocks along the sliding faces of said base.

2. The cutter module as claimed in claim 1, wherein the sliding faces of said base are reversed and arranged in parallel, the sliding faces of said cutter are faced with each other and arranged in parallel.

3. The cutter module as claimed in claim 2, wherein said cutter comprises a cutter body and two mounting portions, said cutter body having a front side, a back side, two opposite lateral sides, and two opposite short sides, said mounting portions being respectively perpendicularly extended from the back side of said cutter body along the two opposite short sides of said cutter body, the sliding faces of said cutter being formed integral with the mounting portions of the cutter perpendicular to the back side of the cutter body of the cutter.

4. The cutter module as claimed in claim 1, wherein said base comprises a die block receiving opening extended through said first lateral side and said second lateral side, and a die block mounted in said die block receiving opening, said die block comprising a block body received in said die block receiving opening, said block body having a top sidewall disposed in flush with the first lateral side of said base, a bottom sidewall, and two opposite lateral sidewalls, and two mounting flanges respectively outwardly extended from the bottom sidewall of said block body along the two opposite lateral sidewalls of said block body, said mounting flanges each having a through hole fixedly fastened to the second lateral side of said base by a screw.

5. The cutter module as claimed in claim 4, wherein said block body of said die block has two chamfered edges respectively connected between the two opposite lateral sidewalls and top sidewall of said block body; the cutting edge of said cutter has two arched portions fitting the chamfered edges of said die block and being moved with said sliding blocks over the chamfered edges of said die block upon each cutting operation.
